(19) United States
(12) Patent Application Publication
(10) Pub. No.: US 2010/0266114 A1
(43) Pub. Date: Oct. 21, 2010

(54) MULTIMEDIA TERMINAL ADAPTER AND AUTOMATIC CALL FORWARDING METHOD

(75) Inventors: HUAI-CHIH FAN, Tu-Cheng (TW); CHIH-FENG LAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/535,034

(22) Filed: Aug. 4, 2009

(30) Foreign Application Priority Data
Apr. 20, 2009 (CN) 200910301688.6

(51) Int. Cl. H04M 7/00

(52) U.S. Cl. 379/229

(57) ABSTRACT

A multimedia terminal adapter (MTA) electronically connected to a call management server and phone sets configured in at least two different networks, includes a receiving module and a control module. The control module drives the phone sets configured in the at least two different networks to ring when the receiving module receives a call from the call management server, receives an off-hook signal from one of the phone set configured in a network, controls other phone sets configured in other networks to stop ringing, and sends the off-hook signal and Internet protocol (IP) port information of the off-hook phone set to the call management server.

### BACKGROUND

1. Technical Field

The disclosure relates to multimedia terminal adapters, and particularly to a multimedia terminal adapter and call forwarding method thereof.

2. Description of Related Art

With increasing need for communications, there are a plurality of different networks to provide telecommunication services in homes or offices. Different phone sets may only work with a particular network, such as a multimedia terminal adapter (MTA) network or the Internet network. That is, a phone set configured in the MTA network may not be able to handle calls via the Internet network, and a phone set configured in the Internet network may not be able to handle calls via the MTA network. Thus, if there is a call via a network, a user must find out which phone set has rang, which is inconvenient.

### BRIEF DESCRIPTION OF THE DRAWINGS

FIG. 1 is a schematic diagram of an application environment of a multimedia terminal adapter.

FIG. 2 is a schematic diagram of one embodiment of a multimedia terminal adapter as disclosed.

FIG. 3 is a flowchart of a first embodiment of an automatic call forwarding method as disclosed.

FIG. 4 is a flowchart of a second embodiment of an automatic call forwarding method as disclosed.

### DETAILED DESCRIPTION

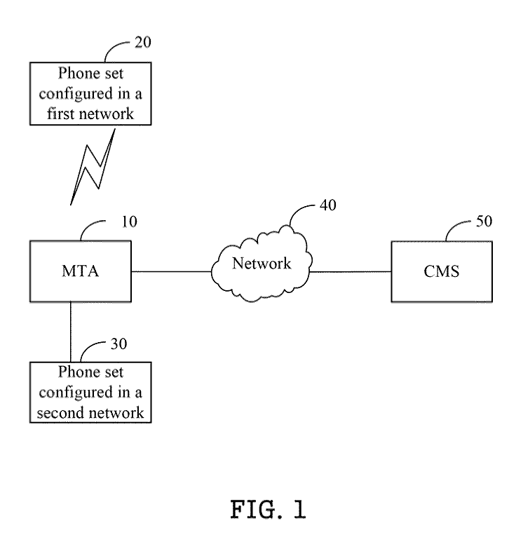

FIG. 1 is a schematic diagram of an application environment of a multimedia terminal adapter (MTA) 10. The MTA 10 is electronically connected to phone sets configured in at least two different networks in a same place, such as, in a same office or home. To simplify discussion of the MTA 10, FIG. 1 shows only a phone set 20 configured in a first network and a phone set 30 configured in a second network are shown. The phone set 20 configured in the first network may be a WLAN phone wirelessly connected to the MTA 10, and the phone set 30 configured in the second network may be a MTA phone connected to the MTA 10 by wires. The MTA 10 is also electronically connected to a call management server (CMS) 50 via a network 40, and forwards calls from the CMS 50 between the phone set 20 configured in the first network and the phone set 30 configured in the second network. The calls may be from other phone sets not in a same office/home with the phone sets 20 and 30. The CMS 50 may be a soft switch device, and the network 40 may includes different networks, such as a MTA network and the Internet network.

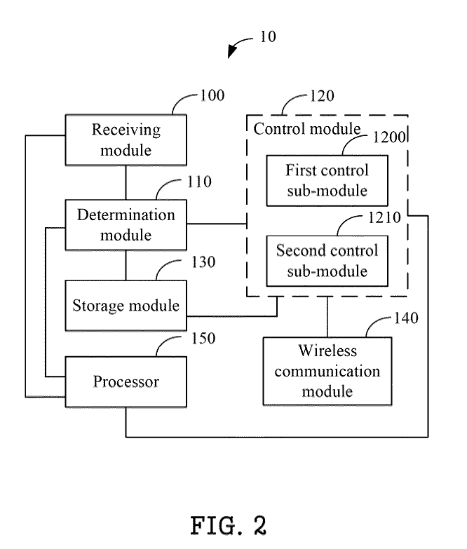

FIG. 2 is a schematic diagram of one embodiment of the MTA 10 as disclosed. The MTA 10 includes a receiving module 100, a determination module 110, a control module 120, a storage module 130, and a processor 150. The receiving module 100 receives a call from the CMS 50. When the receiving module 100 receives the call from the CMS 50, the control module 120 drives the phone set 20 configured in the first network and the phone set 30 configured in the second network to ring. If one of the phone sets is picked up, the control module 120 further receives an off-hook signal from the one of the phone sets, as well as controls the other phone sets to stop ringing. The control module 120 further sends the off-hook signal and Internet protocol (IP) port information of the off-hook phone set to the CMS 50. Thus, it does not matter if which network receives a call because all the phone sets configured in the different networks all ring, and a user can answer the call by picking up any one phone set, which brings much convenience. The processor 150 executes one or more computerized instructions for the receiving module 100, the determination module 110, and the control module 120.

The storage module 130 is connected to the determination module 110 and the control module 120, and stores IP port information and state information of the phone set 20 configured in the first network and the phone set 30 configured in the second network. The state information includes a connected/registered state and a disconnected/unregistered state. The phone set 20 configured in the first network sends registering messages to the MTA 10 to register via the MTA 10 when the phone set 20 configured in the first network is powered on. In one embodiment, the registering message may include IP port information and a user name of the phone set 20 configured in the first network. The phone set 20 retrieves a password to communicate via the MTA 10 and the network 40 after being registered. The MTA 10 retrieves the IP port information of the phone set 20 configured in the first network from the registering messages, and stores the IP port information and the state information of the phone set 20 configured in the first network to the storage module 130. The MTA 10 determines if the phone set 30 configured in the second network is connected thereto, and stores state information and IP port information of the phone set 30 configured in the second network to the storage module 130 according to the determination.

In one embodiment, the determination module 110 is connected to the receiving module 100, and determines if the MTA 10 can forward calls when the receiving module 100 receives the call from the CMS 50 according to the state information of the phone set 20 configured in the first network and the phone set 30 configured in the second network. In alternative embodiments, because the phone set 30 configured in the second network is wired connected to the MTA 10, which is seldom disconnected, the determination module 110 determines if the MTA 10 can forward calls only according to the state information of the phone set 20 configured in the first network. If one of the phone set 20 configured in the first network and the phone set 30 configured in the second network is disconnected/unregistered, the determination module 110 determines the MTA 10 cannot forward calls. If the phone set 20 configured in the first network and the phone set 30 configured in the second network are both connected/registered, the determination module 110 determines the MTA 10 can forward calls. The determination module 110 further determines a called phone set according to phone numbers of the call received by the receiving module 100.

In one embodiment, the control module 120 includes a first control sub-module 1200 and a second control sub-module 1210. The first control sub-module 1200 drives the phone set 20 configured in the first network to ring when the receiving module 100 receives a call via the first network or the determination module 110 determines that the MTA 10 can forward calls. The first control sub-module 1200 further receives an off-hook signal from the phone set 20 configured in the first network, and sends the off-hook signal and the IP port information of the phone set 20 configured in the first network to the CMS 50 to establish a communication with a caller.

The second control sub-module 1210 drives the phone set 30 configured in the second network to ring when the receiving module 100 receives a call via the second network or the determination module 110 determines that the MTA 10 can forward calls. The second control sub-module 1210 further receives an off-hook signal from the phone set 30 configured in the second network, and sends the off-hook signal and the IP port information of the phone set 30 configured in the second network to the CMS 50 to establish a communication with a caller. In one embodiment, the first control sub-module 1200 and the second control sub-module 1210 retrieves the IP port information of corresponding phone sets from the storage module 130.

The first control sub-module 1200 further controls the phone set 20 configured in the first network to stop ringing when the second control sub-module 1210 receives the off-hook signal from the phone set 30 configured in the second network. The second control sub-module 1210 also controls the phone set 30 configured in the second network to stop ringing when the first control sub-module 1200 receives the off-hook signals from the phone set 20 configured in the first network. In one embodiment, the first control sub-module 1200 may be a session initiation protocol (SIP) sub-module wirelessly connected to the phone set 20 configured in the first network, and the second control sub-module 1210 may be a MTA telephone control sub-module connected to the phone set 30 configured in the second network by wires.

The first control sub-module 1200 sends invite messages to the phone set 20 configured in the first network to establish a communication therebetween and to make the phone set 20 configured in the first network ring. If the phone set 20 configured in the first network has registered, the phone set 20 configured in the first network responses, such as, a response of 180. If the first control sub-module 1200 receives no responses to the invite messages, the first control sub-module 1200 determines that the phone set 20 configured in the first network has not registered or has disconnected, and stores the disconnected/unregistered state to the storage module 130.

In one embodiment, the MTA 10 is a wireless MTA, and further includes a wireless communication module to connect the first control sub-module 1200 and the phone set 20 configured in the first network.

The MTA 10 can automatically forward calls between the phone set 20 configured in the first network and the phone set 30 configured in the second network, thus, users can answer calls via a phone set configured in any network without help of service providers, which is convenient and reduces costs.

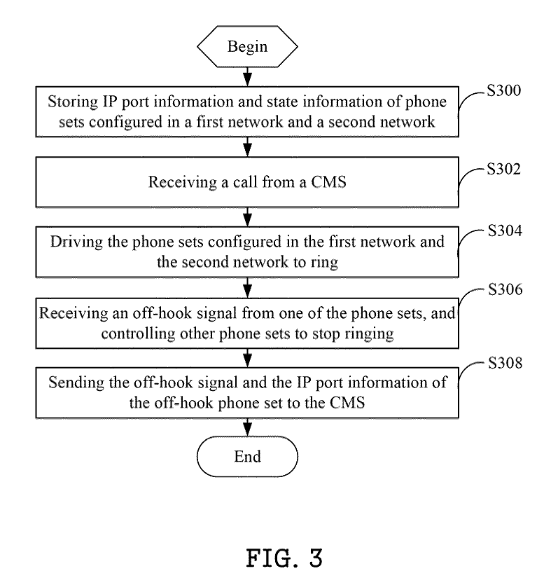

FIG. 3 is a flowchart of a first embodiment of an automatic call forwarding method of the MTA 10 as disclosed. First, the CMS 50 receives a call from a phone set not in a same place with the MTA 10 (e.g., the phone set making the call is in an office and the MTA 10 is in a home), and sends the call to the MTA 10. In block S300, the storage module 130 stores IP port information and state information of the phone set 20 configured in the first network and the phone set 30 configured in the second network, and the state information includes a connected/registered state and a disconnected/unregistered state. In block S302, the receiving module 100 receives the call from the CMS 50.

In block S304, the control module 120 drives the phone set 20 configured in the first network and the phone set 30 configured in the second network to ring. In one embodiment, the first control sub-module 1200 and the second control sub-module 1210 drive the phone set configured in corresponding network to ring respectively. In block S306, the control module 120 receives an off-hook signal from one of the phone sets 20 and 30, such as, the phone set 20 configured in the first network, and controls the phone set 30 configured in the second network to stop ringing.

In block S308, the control module 120 sends the off-hook signal and the IP port information of the phone set 20 configured in the first network to the CMS 50 to establish a communication.

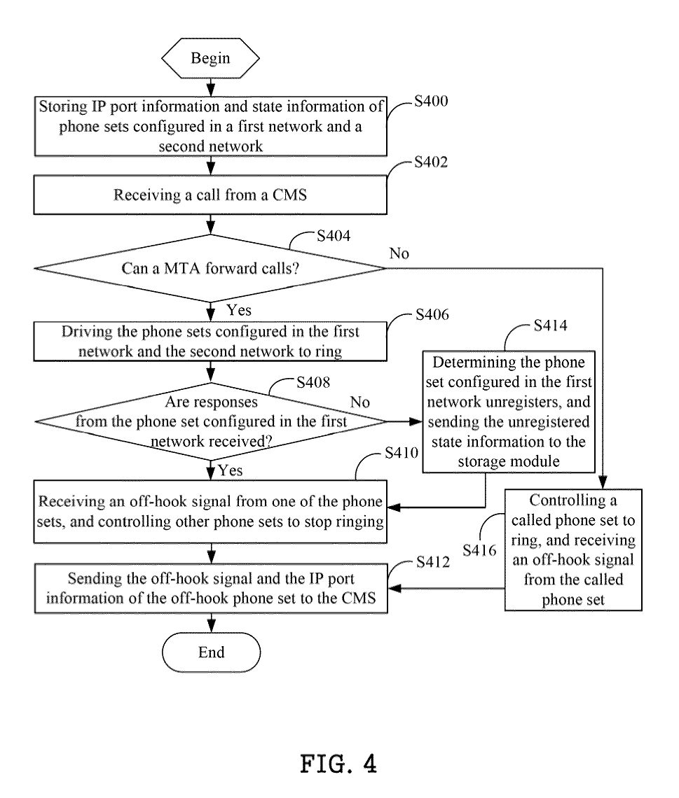

FIG. 4 is a flowchart of a second embodiment of an automatic call forwarding method of the MTA 10 as disclosed. First, the CMS 50 receives a call from a phone set not in a same place with the MTA 10, and sends the call to the MTA 10 (e.g., the phone set making the call is in an office and the MTA 10 is in a home). In block S400, the storage module 130 stores IP port information and state information of the phone set 20 configured in the first network and the phone set 30 configured in the second network, and the state information includes a connected/registered state and a disconnected/unregistered state. In block S402, the receiving module 100 receives the call from the CMS 50. In block S404, the determination module 110 determines if the MTA 10 can forward calls. In one embodiment, the determination module 110 determines if the MTA 10 can forward calls according to the state information of the phone set 20 configured in the first network and the phone set 30 configured in the second network.

If the MTA 10 can forward calls, in block S406, the first control sub-module 1200 sends invite messages to the phone set 20 configured in the first network, and makes the phone set 20 configured in the first network ring, and the second control sub-module 1210 drives the phone set 30 configured in the second network to ring. In block S408, the first control sub-module 1200 determines if responses from the phone set 20 configured in the first network are received. If responses are received, in block S410, a control sub-module receives an off-hook signal from a phone set configured in a corresponding network, and another control sub-module controls a phone set configured in a corresponding network to stop ringing. In block S412, the control sub-module corresponding to the off-hook phone set sends the off-hook signal and the IP port information of the off-hook phone set to the CMS 50 to establish a communication.

If no responses are received from the phone set 20 configured in the first network, in block S414, the first control sub-module 1200 determines that the phone set 20 configured in the first network disconnects/unregisters, and sends the disconnected/unregistered state information of the phone set 20 configured in the first network to the storage module 130. Then the process goes to block S410, however, at this time, only the phone set 30 configured in the second network can answer calls.

If the MTA 10 can not forward calls, in block S416, the control module 120 drives a called phone set to ring, and receives an off-hook signal from the called phone set. Then, process goes to block S412.

The following are examples of the automatic call forwarding method of the MTA 10. First, the receiving module 100 receives a call from the CMS 50. Then, the determination module 110 determines if the MTA 10 can forward calls. If the MTA 10 can not forward calls, the control module 120 only drives a called phone set to ring, and establishes a communication between the called phone set and a caller.

If the MTA 10 can forward calls and the called phone set is the phone set 20 configured in the first network, the control module 120 drives both of the phone set 20 configured in the first network and the phone set 30 configured in the second network to ring, and determines if any phone set is picked up. If the phone set 30 configured in the second network is picked up, the control module 120 establishes a communication between the caller and the phone set 30 configured in the second network. Thus, automatic call forwarding from the phone set 20 configured in the first network to the phone set 30 configured in the second network is implemented.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A multimedia terminal adapter electronically connected to a call management server and phone sets configured in at least two different networks, comprising:
a receiving module to receive a call from the call management server; and
a control module to drive the phone sets configured in the at least two different networks to ring;
wherein upon receiving an off-hook signal from one of the phone sets configured in a network of the at least two different networks, the control module controls the other phone sets configured in the other networks of the at least two different networks to stop ringing, and sends the off-hook signal and Internet protocol (IP) port information of the off-hook phone set to the call management server; and
a processor to execute one or more computerized instructions for the receiving module and the control module.

2. The multimedia terminal adapter of claim 1, further comprising a storage module to store IP port information and state information of the phone sets configured in the at least two different networks, wherein the state information comprises a connected/registered state and a disconnected/unregistered state.

3. The multimedia terminal adapter of claim 2, further comprising a determination module to determine if the multimedia terminal adapter can forward calls according to the state information of the phone sets configured in the at least two different networks stored in the storage module.

4. The multimedia terminal adapter of claim 2, wherein the control module comprises:
a first control sub-module to drive a phone set configured in a first network to ring, receive an off-hook signal from the phone set configured in the first network, and to send the off-hook signal and IP port information of the phone set configured in the first network to the call management server; and
a second control sub-module to drive a phone set configured in a second network to ring, receive an off-hook signal from the phone set configured in the second network, and to send the off-hook signals and IP port information of the phone set configured in the second network to the call management server.

5. The multimedia terminal adapter of claim 4, wherein the first control sub-module further controls the phone set configured in the first network to stop ringing when the second control sub-module receives the off-hook signal from the phone set configured in the second network, and the second control sub-module further controls the phone set configured in the second network to stop ringing when the first control sub-module receives the off-hook signal from the phone set configured in the first network.

6. The multimedia terminal adapter of claim 4, wherein the first control sub-module is a session initiation protocol (SIP) control sub-module wirelessly connected to the phone set configured in the first network, and the second sub-module is a multimedia terminal adapter telephone control sub-module connected to the phone set configured in the second network by wires.

7. The multimedia terminal adapter of claim 6, further comprising a wireless communication module to connect the first control sub-module and the phone set configured in the first network.

8. The multimedia terminal adapter of claim 6, wherein the first control sub-module sends invite messages to the phone set configured in the first network to establish a communication therebetween and to make the phone set configured in the first network ring.

9. The multimedia terminal adapter of claim 8, wherein upon receiving no responses to the invite messages, the first control sub-module determines that the phone set configured in the first network disconnects/unregisters, and stores the disconnected/unregistered state information of the phone set configured in the first network to the storage module.

10. An automatic call forwarding method of a multimedia terminal adapter, comprising:
receiving a call from a call management server;
driving phone sets configured in at least two different networks to ring; and
receiving an off-hook signal from a phone set configured in a first network, controlling a phone set configured in a second network to stop ringing, and sending the off-hook signal and Internet protocol (IP) port information of the phone set configured in the first network to the call management server.

11. The automatic call forwarding method of claim 10, further comprising storing IP port information and state information of the phone sets configured in the at least two different networks, wherein the state information comprises a connected/registered state and a disconnected/unregistered state.

12. The automatic call forwarding method of claim 11, further comprising determining if the multimedia terminal adapter can forward calls according to the stored state information of the phone sets configured in the at least two different networks.

13. The automatic call forwarding method of claim 11, wherein driving phone sets configured in at least two different networks to ring comprises:
driving the phone set configured in the first network to ring by a first control sub-module; and
driving the phone set configured in the second network to ring by a second control sub-module.

14. The automatic call forwarding method of claim 13, wherein receiving an off-hook signal from a phone set configured in a first network, controlling a phone set configured in a second network to stop ringing, and sending the off-hook signal and Internet protocol (IP) port information of the phone set configured in the first network to the call management server comprises:
receiving the off-hook signal from the phone set configured in the first network by the first control sub-module;
controlling the phone set configured in the second network to stop ringing by the second control sub-module; and
sending the off-hook signal and the IP port information of the phone set configured in the first network to the call management server by the first control sub-module.

15. The automatic call forwarding method of claim 13, further comprising:
sending invite messages to the phone set configured in the first network to establish a communication therebetween, and making the phone set configured in the first network ring by the first control sub-module.

16. The automatic call forwarding method of claim 15, further comprising:
determining that the phone set configured in the first network disconnects/unregisters, and storing the disconnected/unregistered state information of the phone set configured in the first network to a storage module when the first control sub-module receives no responses to the invite messages.
